(19) United States
(12) Patent Application Publication
(10) Pub. No.: US 2010/0191568 A1
(43) Pub. Date: Jul. 29, 2010

(54) APPARATUS AND METHOD FOR MANAGING TASK INFORMATION OF A PLANT

(75) Inventors: Naveen Kashyap, Singapore (SG); Hirofumi Takahashi, Singapore (SG); Priyalatha Hariharan, Singapore (SG); Althea Remos Umali, Singapore (SG)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 12/609,838

(22) Filed: Oct. 30, 2009

(30) Foreign Application Priority Data
Jan. 23, 2009 (SG) 200900561-2

(51) Int. Cl. G06Q 10/00; G06Q 50/00; G06F 15/16

(52) U.S. Cl. 705/9; 705/7; 709/203

(57) ABSTRACT

An apparatus for managing task information of a plant, the plant being controlled by a control system and configured to be operated in shifts. The apparatus comprises a server for automatically obtaining and storing information from a current work shift of the plant from the control system; and at least one client connected to the server and comprising a logbook application module for manipulating the obtained information. Preferably, the server is configured to automatically transmit manipulated information to identified users of a subsequent work shift.

### TECHNICAL FIELD

The present invention relates to an apparatus and method for managing task information of a plant. It particularly relates to a method and apparatus for managing task information of a plant that is operated in shifts.

### BACKGROUND OF THE INVENTION

Plants that are configured to operate in shifts typically employ different teams of plant personnel for each shift. The team for each work shift normally comprises a shift supervisor and a plurality of operators who may include engineers, maintenance staff, and workers of other designations.

As shown in FIG. 1, during a current work shift of a plant 10, each plant operator 20, where applicable, uses a logbook 30 to record information 32 of the current work shift for the various aspects or particular section of the plant that the operator 20 is specifically in charge of. This typically includes on-going task information of one or more activities and status information for various pieces of equipment as well as other operational information that are generated by the plant and captured by a control system controlling the plant 10. The information is normally displayed to the operator 20 on an operator console 40 on a client machine. Operator comments, evidences of work completion, events deemed significant by the operator 20, equipment diagrams with handwritten annotations and so on are also commonly maintained by each operator 20 in his own logbook 30. On top of his individual logbook records, each operator 20 may also contribute input 52 to a production summary record 50 that comprises values that are sampled at various time instances.

Currently, at the end of every work shift, each operator 20 signs off on his own logbook 30 and the shift supervisor 60 collects 62 all the logbooks 30 and the production summary record 50 from the plurality of operators 20 in his team. From the information in all the logbooks and production summary records, the shift supervisor generates 64 a work shift summary report 70. The work shift summary report 70 together with all the logbooks 30 are then handed over 72 to another team 80 of plant personnel who will be operating the plant 10 in the subsequent work shift. The handing over normally takes place at a shift hand-over meeting 90 of shift supervisors 60 that lasts around twenty to thirty minutes in an overlapping time interval between work shifts, comprising some five to eight percent of a work shift effort. The shift supervisor 60 of the subsequent work shift then updates his team 80 of operators 20 with the current shift information prior to starting work on their subsequent shift. This is repeated at the end of every work shift.

Each operator 20 thus personally decides what information he sees on his operator console 40 and which parts of his activities (including communication with other shift members) to record in his logbook 30 and the production summary record 50, and each shift supervisor 60 also personally decides what information he will summarize in his work shift summary report 70 or transmit to his team 80 of operators. Consequently, the quality, quantity and interpretation of plant information for each work shift are subjective and highly dependent on the individual plant personnel involved. This also means that information recorded in the logbooks 30 is not fully traceable to actual information generated by the plant 10.

In addition, writing in their paper logbooks 30 or keying in data into digital logbooks 30 is a time consuming task for the operators 20. Handwritten reports also often suffer from legibility and insufficiency problems. It is also time consuming for the shift supervisor 60 to sift through all the logbooks 30 of his team 80 and generate the work shift summary report 70. Obtaining historical information for further data analyses is difficult as the information is scattered in multiple logbooks 30 and a common context is missing. Much pre-processing and data re-entry is required if computerized software tools are to be used to analyze the information obtained for each work shift.

### SUMMARY OF THE INVENTION

According to a first aspect, there is provided an apparatus for managing task information of a plant, the plant being controlled by a control system and configured to be operated in shifts. The apparatus comprises a server for automatically obtaining and storing information from a current work shift of the plant from the control system; and at least one client connected to the server and comprising a logbook application module for manipulating the obtained information. Preferably, the server is configured to automatically transmit manipulated information to identified users of a subsequent work shift.

The server may further comprise a report generator module for generating work shift reports from the manipulated obtained information, a report scheduler module for scheduling generation of the work shift reports, a follow-up task creator module for generating follow-up tasks and reminders for a subsequent work shift, a shift user resolver module to automatically alert identified users of the subsequent work shift to the follow-up tasks and reminders, and/or a database for storing information therein.

According to a second aspect, there is provided a method for managing task information of a plant, the plant being controlled by a control system and configured to be operated in shifts. The method comprises obtaining information of a current work shift of the plant from the control system; storing the obtained information in a server; and manipulating the obtained information via a logbook application module in a client connected to the server. The method preferably further comprises automatically transmitting manipulated information to identified workers of a subsequent work shift.

The method may further comprise generating work shift reports from the manipulated obtained information via a report generator module in the server, scheduling the generation of the shift reports via a report scheduler module in the server, and generating follow-up tasks and reminders for a subsequent work shift via a follow-up task creator module in the server. In the method, modules in the server are preferably controlled via a user interface in the logbook application module.

For both aspects, the logbook application module preferably comprises a user interface configured to control modules in the server. The logbook application module may further comprise at least one function selected from the group consisting of: screen capture, screen annotation, adding task information, searching for previous reports, displaying and acknowledging follow-up tasks and associated reminders, and adding Uniform Resource Locators to shift reports.

### BRIEF DESCRIPTION OF THE DRAWINGS

Exemplary embodiments will now be described with reference to the accompanying drawings, by way of example only, in which:

FIG. 1 is a schematic diagram of a prior art information management workflow during a change of work shift;

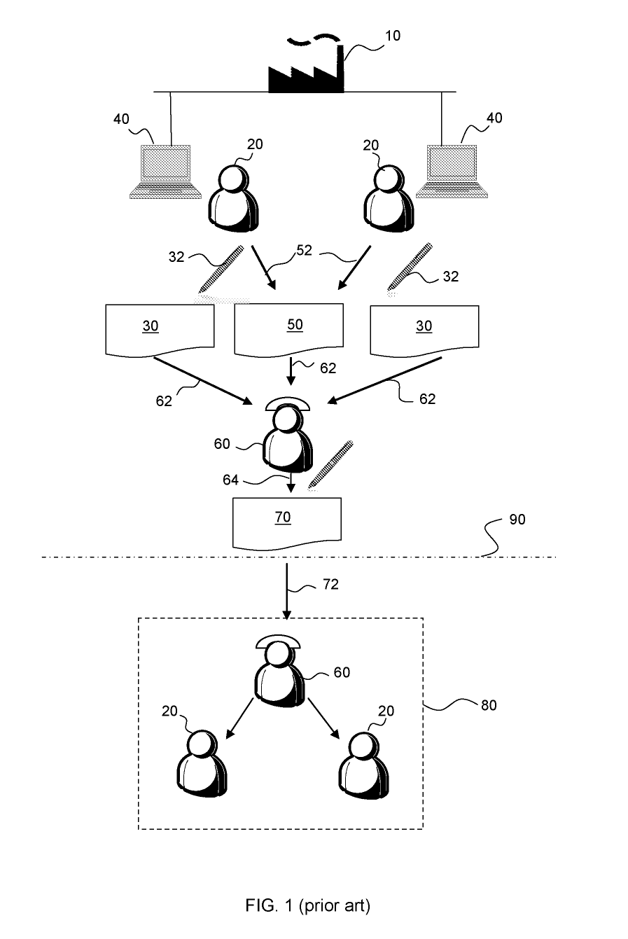

FIG. 2 is a schematic diagram of an exemplary embodiment of information management workflow during a change of work shift according to the present invention;

FIG. 3 is a flowchart corresponding to the exemplary embodiment of FIG. 2;

FIG. 4 is a block diagram of an exemplary embodiment of the apparatus according to the invention; and

FIG. 5 is an exemplary screen shot of a logbook application module 44 on a client machine.

### DETAILED DESCRIPTION OF THE EMBODIMENTS

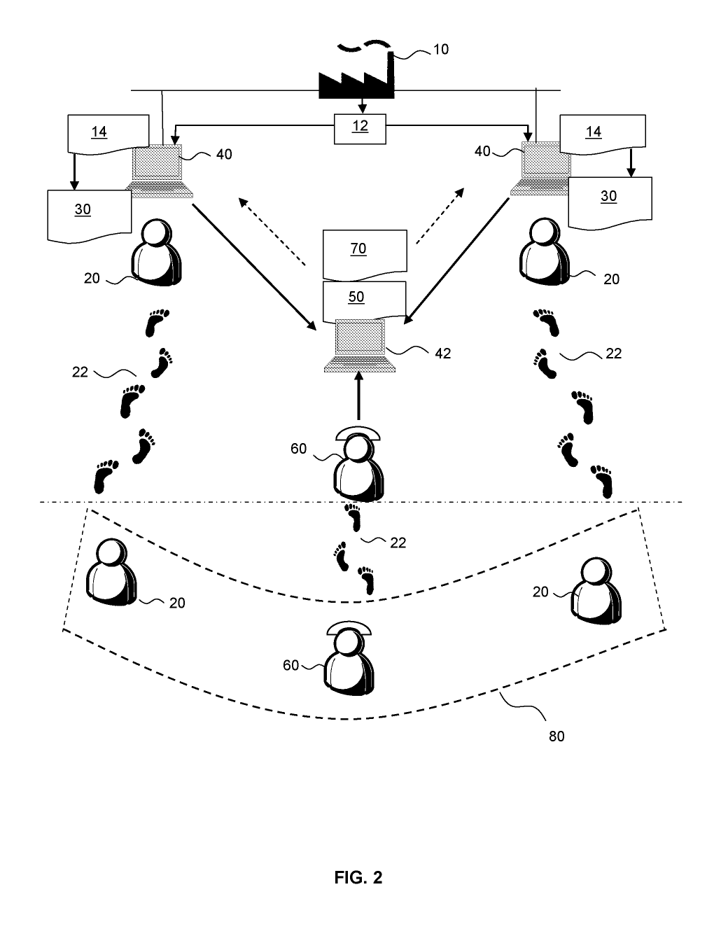

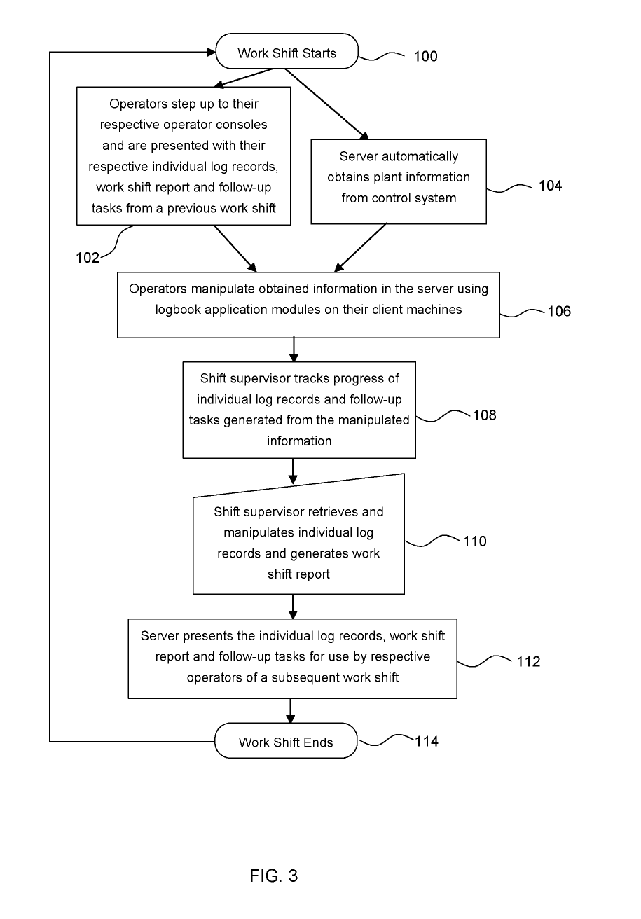

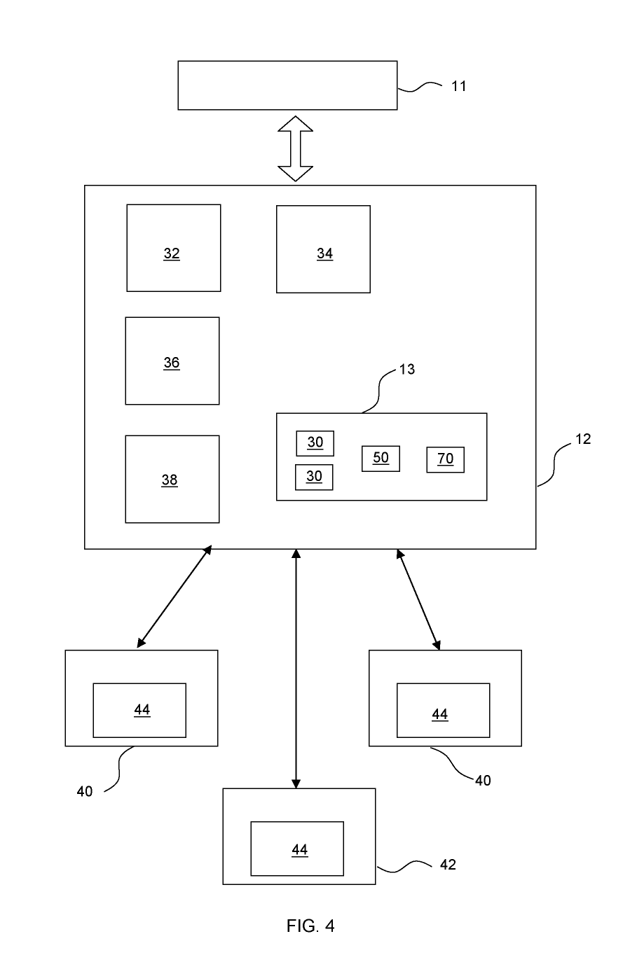

An exemplary embodiment of an apparatus and method for information management workflow of a plant during a change of work shift according to the present invention is described with reference to FIGS. 2 to 4, wherein plant information from each work shift is made highly traceable, simple to generate, easy to retrieve and readily available. As shown in FIGS. 2 to 4, the plant 10 is controlled by a control system 11 that captures information generated by various aspects and pieces of equipment that the plant 10 comprises. A server 12 is provided that automatically obtains information from the plant 10 at scheduled intervals, or on demand as appropriate, from data sources such as the control system 11 and any other task based operation systems 104. The information obtained by the server 12 may include alarms and events form the control system 11, check lists, task related information from the task basked operation system, cycle time statistics, reports of resources consumed by various tasks and so on. Obtained information 14 from the various plant operations is preferably stored in a database 13 in the server 12 and grouped by tasks or operational objectives or in any other appropriate manner. In this way, relevant contextual information is also implicitly captured, thereby simplifying knowledge management of the plant 10. This also helps to avoid re-work and to improve reliability of the obtained information 14.

At the start of a work shift 100, the operators 20 and shift supervisor 60 step up 22 to their respective operator consoles 40, 42, 102 from which they control the plant 10. Each operator consoles 40 is connected as a client to the server 12. Obtained information 14 from the server 12 is consolidated by a report generator module 36 in the server 12 and provided to the operators 20 on their respective operator consoles 40.

A logbook application module 44 is provided on each client operator console 40, 42. The logbook application module 44 comprises a graphical user interface configured for manipulating the obtained information 14, allowing the operators 20 and shift supervisor 60 to key in comments and make other entries to their respective records. Via the logbook application module 44, each operator 20 or the supervisor 60 controls various modules in the server 12 and manipulates the obtained information 14, 106 by making selections, entering additional data such as comments or task or status information that may not have been captured by the control system 11, and also contribute input to a production summary record 50. Alternatively, the production summary record 50 may be directly generated by the operator 20 when default entries provided by the server 12 from the obtained information 14 are found to be acceptable and no additional user inputs are required.

Each operator 20 may also create follow-up tasks for relevant operators of the subsequent work shift using a follow-up task creator module 32 in the server 12. Alternatively, the follow-up task creator module 32 may be configured to automatically create follow-up tasks for a relevant operator 20 of the subsequent shift and to send reminders and/or other alerts to the relevant operator 20. In this way, operators 20 in a subsequent shift may be automatically alerted to follow-up tasks during their shift, ensuring that no information is lost and that no important actions are missed. Tracking of follow-up tasks may be facilitated by way of shift level key performance indicators (KPI) such as the number of tasks completed on time, the amount of backlog cleared, the number of process alarms raised during the current shift, whether the time taken to complete any of the tasks bettered the historical performance record, and so on, to better ensure that the follow-up tasks have been performed satisfactorily.

To manage different shift operators, a shift user resolver module 34 may be provided in the server 12 to automatically check a shift roster to identify users of a subsequent work shift and send relevant information, follow-up tasks, reminders and alerts to them. Preferably, the shift user resolver module 34 also creates a new page for the operator logbook 30 of the subsequent shift, based on a predetermined shift timing configuration.

In a preferred embodiment, the logbook application module 44 is further configured to allow each operator 20 to also perform screen captures and make screen annotations to the presented information 14. By manipulating obtained information 14 through the logbook application module 44, each operator 20 thus generates an individual logbook or log record 30 associated with the respective operator console 40. Information in each individual logbook or log record 30 is preferably stored in the server 12 on the database 13.

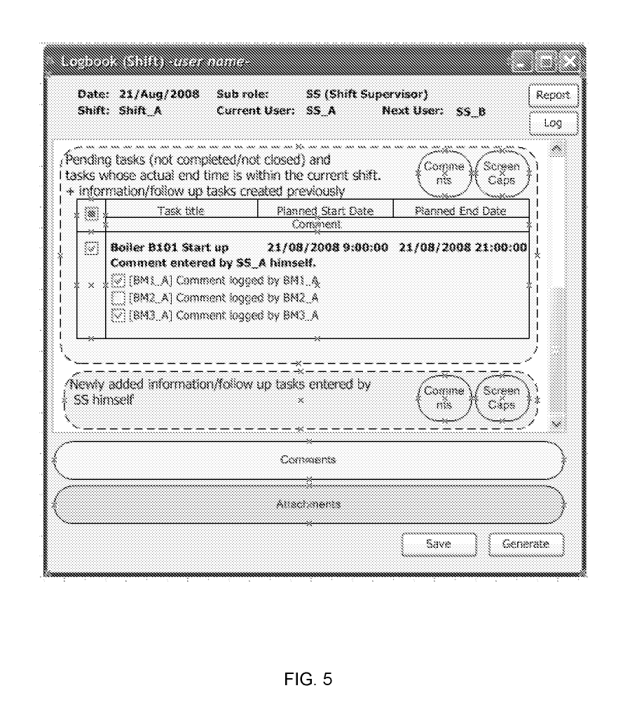

The shift supervisor 60 of each work shift tracks the progress of the individual operators 20 via their log records 30 as well as the follow-up tasks generated 108. The shift supervisor 60 preferably operates from a dedicated operator console 42 comprising a shift supervisor logbook application module 44. This special logbook application module 44 allows the shift supervisor 60 to retrieve and manipulate information obtained from the individual logbooks 30 and to control the report generator module 36 in the server 12 in order to generate work shift reports 70, 110 for the subsequent work shift. An exemplary screen shot of a report generator user interface of the shift report generator module 36 on an operator console 40, 42 is shown in FIG. 5.

Preferably, whenever an operator 20 updates his individual logbook 30, entries made are instantaneously accessible to the shift supervisor 60 on his operator console 42. The shift supervisor 60 may therefore make concurrent selections of tasks or related information from the logbooks 30 and production summary 50 for inclusion in the shift report 70, and also enter comments using the graphical user interface on his console 42 when generating the work shift report 70. In addition to the operators 20 or supervisor 60 triggering the report generator module 36 to generate reports, the server 12 may further comprise a report scheduler module 38 for scheduling generation of the work shift reports 70. By allowing the operators 20 and supervisor 60 to compile summaries and update their logbooks 30 as the work shift progresses, the apparatus and method save time and pressure at the end of a work shift to produce completed logbooks 30 is eliminated. Also, trends and operator screen may be captured as screen images together with annotation for illustration purposes for inclusion in the logbooks 30, summary reports 50 and shift reports 70.

In addition to manipulating obtained information 14, the logbook application module 44 on each client 40, 42 is preferably also configured to allow an operator 20 or supervisor 60 to search for and view earlier work shift reports 70 and logbooks 30 “on the fly”, display and acknowledge follow-up tasks and associated reminders, and even add Uniform Resource Locators of other sources of information to their individual logbooks 30 and/or work shift reports 70, thereby reducing duplication of effort and information.

As the current work shift draws to a close, the server 12 automatically presents the individual log records 30, work shift report 70, follow-up tasks and any other relevant information, reminders or alerts for use by the team 80 of operators 20 and supervisor 60 of the subsequent shift 112. In this way, there is no need for a substantial shift hand-over meeting for the supervisor of the current to pass important work shift information on to the supervisor of the subsequent shift when the work shift ends 114. Instead, the subsequent team 80 start their work shift 100 with simply stepping up to their respective operator consoles 40, 42, 102. At their operator consoles 40, 42, the subsequent team 80 are presented with the relevant information such as the respective individual log records 30, work shift report 70 and any follow-up tasks and reminders generated from the previous work shift.

The apparatus and method therefore provide all operators 20 and supervisors 60 with access to all the plant operation information that is relevant to them as necessary or desired, thereby keeping them fully informed of plant processes. There is therefore little or no chance of misinformation or information loss since there is greatly reduced dependency on human intervention to transmit information from a current to subsequent work shifts. The transmitted information would also be free of subjective interpretation errors.

It should be appreciated that the invention has been described by way of example only and that various modifications in design and/or detail may be made without departing from the spirit and scope of this invention. For example, additional user interfaces for access to the logbooks on the server may be provided on hand-held devices for use by mobile field personnel. Voice data input or digital pen data input systems may be used in addition to or as an alternative to keyboard data entry on the operator consoles. Keyword search functions may be provided to allow searching through the database of previous logbooks and work shift reports for specific information. The server may be configured to provide an updated shift backlog summary based on the shift plan at the start of a shift and the actual plant or activity status at the end of the shift. The server may further be configured to provide a function to compare shift reports of multiple shifts for similar activities, tasks and/or related performance indicator such as cycle time and so on.

1. An apparatus for managing task information of a plant, the plant being controlled by a control system and configured to be operated in shifts, the apparatus comprising:
a server for automatically obtaining and storing information from a current work shift of the plant from the control system; and
at least one client connected to the server and comprising a logbook application module for manipulating the obtained information.

2. The apparatus of claim 1, wherein the server is configured to automatically transmit manipulated information to identified users of a subsequent work shift.

3. The apparatus of claim 1, wherein the server further comprises a report generator module for generating work shift reports from the manipulated obtained information.

4. The apparatus of claim 3, wherein the server further comprises a report scheduler module for scheduling generation of the work shift reports.

5. The apparatus of claim 1, wherein the server further comprises a follow-up task creator module for generating follow-up tasks and reminders for a subsequent work shift.

6. The apparatus of claim 5, wherein the server is further comprises a shift user resolver module to automatically alert identified users of the subsequent work shift to the follow-up tasks and reminders.

7. The apparatus of claim 1, further comprising a database in the server for storing information therein.

8. The apparatus of claim 1, wherein the logbook application module comprises a user interface configured to control modules in the server.

9. The apparatus of claim 1, wherein the logbook application module comprises at least one function selected from the group consisting of: screen capture, screen annotation, adding task information, searching for previous reports, displaying and acknowledging follow-up tasks and associated reminders, and adding Uniform Resource Locators to shift reports.

10. A method for managing task information of a plant, the plant being controlled by a control system and configured to be operated in shifts, the method comprising:
obtaining information of a current work shift of the plant from the control system;
storing the obtained information in a server; and
manipulating the obtained information via a logbook application module in a client connected to the server.

11. The method of claim 10, further comprising automatically transmitting manipulated information to identified workers of a subsequent work shift.

12. The method of claim 10, further comprising generating work shift reports from the manipulated obtained information via a report generator module in the server.

13. The method of claim 12, further comprising scheduling the generation of the shift reports via a report scheduler module in the server.

14. The method of claim 10, further comprising generating follow-up tasks and reminders for a subsequent work shift via a follow-up task creator module in the server.

15. The method of claim 10, wherein modules in the server are controlled via a user interface in the logbook application module.

16. The method of claim 10, wherein the logbook application module comprises at least one function selected from the group consisting of: screen capture, screen annotation, adding task information, searching for previous reports, displaying and acknowledging follow-up tasks and associated reminders, and adding Uniform Resource Locators to shift reports.
